(19) United States
(12) Patent Application Publication
(10) Pub. No.: US 2012/0279639 A1
(43) Pub. Date: Nov. 8, 2012

(54) METHOD FOR FASTENING SEAT AND BACKREST SUPPORT OF LEISURE CHAIRS

(76) Inventors: Lausan Chung-Hsin LIU, Shanghai (CN); Shopo Hsin Tsu Liu, Shanghai (CN); Fibro Tsu Kun Liu, Shanghai (CN)

(21) Appl. No.: 13/102,150

(22) Filed: May 6, 2011

(51) Int. Cl. B32B 38/00; B29C 65/00; B32B 37/02

(52) U.S. Cl. 156/214

(57) ABSTRACT

A method for fastening seat and backrest support of leisure chairs aims to fasten a plurality of strips to a frame of a leisure chair with the frame containing two side tubes and the strip formed at a length greater than the interval between the two side tubes. The method includes the steps of: first, positioning the strips and frame onto a welding machine with the strips straddling the two side tubes; next, bending inversely two ends of each strip towards the center to overlap with the strip and wrap the two side tubes; then welding the overlapped portions of the strips and ends through the welding machine to fasten the two ends of the strip to the two side tubes. The method makes assembly of the strips simpler and can increase production speed of the leisure chairs.

### FIELD OF THE INVENTION

The present invention relates to a method for fastening strips of leisure chairs and particularly to a method for fastening strips to a frame of a leisure chair.

### BACKGROUND OF THE INVENTION

These days increasing of living standard has made people to raise even higher expectation on life quality. To improve comfort and aesthetic appeal at home, many people don't hesitate to purchase various types of household goods, including a wide variety of furniture, such as sofas, chairs and the like. Chairs are some of indispensable furniture to provide comfort for people in the houses, offices and leisure activities.

There are myriad types of chairs on the market with different structures made according to different functions or requirements. Take leisure chairs for instance, R.O.C. patent No. 488244 provides a chair that can be stacked over one another. It mainly has a frame including a seat and a backrest with a plurality of elastic strips fastened to the frame so that resilient support can be provided to the back or the hip of a user to enhance comfort during sitting.

Referring to FIGS. 1 through 5, assembly of the aforesaid leisure chair mainly includes steps of: straddling transversely strips 20 on two side tubes 10 of the frame with corresponding fastening holes 11 and 21 formed respectively on the side tubes 10 and two distal ends of each strip 20 (as shown in FIG. 1); then inserting a fastening element 22 through the fastening holes 11 and 21. However, in practice, one distal end of the strip 20 is fastened first to one side tube 10 (referring to FIG. 2), and the strips 20 is wound a number of times to wrap the fastening holes 11 and 21 and the fastening element 22 to increase fastening strength. After winding, the strip 20 is stretched to another side tube 10 to wrap through another distal end of the strip 20 (referring to FIG. 3). The distal end of the strip 20 is wound on the inmost side (referring to FIG. 4) and is fastened through the fastening element 22 to make the wound structure at two sides symmetrical to form the finished leisure chair (as shown in FIG. 5). The aforesaid fastening approach tends to create the following problems:

1. In general, the distal ends of the strip 20 is wound on the outmost layer, but the distal ends of the strip 20 of the aforesaid leisure chair is wound on the inmost layer during the second winding, which creates difficulty in assembly. As a result, production speed of the leisure chair is adversely affected.

2. Before winding of the strip 20 is performed for the second time, the strip 20 has to be stretched to the side tube 10 at another side. Every worker exerts different stretching forces, and hence each strip 20 is stretched with various degrees of forces. As a result, each strip 20 has different tensions that also affect sitting comfort and impact product quality.

### SUMMARY OF THE INVENTION

The primary object of the present invention is to solve the problems of the conventional method that winding and fastening strips to leisure chairs are difficult and time-consuming and also result in uneven tensions on the strips and impact sitting comfort.

To achieve the foregoing object, the present invention provides a method for fastening strips to leisure chairs that mainly includes steps of: first, providing a frame of a leisure chair with two corresponding side tubes and a plurality of strips each is formed at a length greater than the interval between the two side tubes; positioning the strips and frame onto a welding machine with the strips straddling transversely on the two side tubes; bending inversely two ends of each strip towards the center to overlap the strip and wrap the two side tubes; and finally welding the portions where the strip and the two ends thereof are overlapped to fasten the two ends to the two side tubes. Thus the strips can be fastened to the frame of the leisure chair.

In an embodiment of the invention, the strips are elongated and made of PVC. The frame can be an integral rack or a portion of a rack of a leisure chair. The strips function as a seat or a backrest of the leisure chair to support a user's hip or back during sitting.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1 through 5 are schematic views showing fastening process of a conventional leisure chair.

FIG. 6 is a flowchart of the method of the invention.

FIGS. 7 through 10 are schematic views showing fastening process according to the method of the invention.

FIG. 11 is a schematic view of a preferable embodiment of the invention.

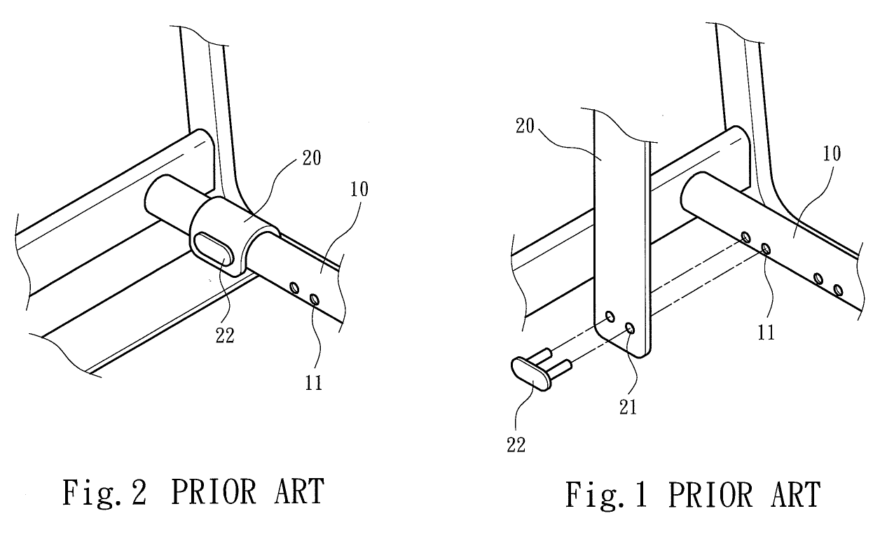

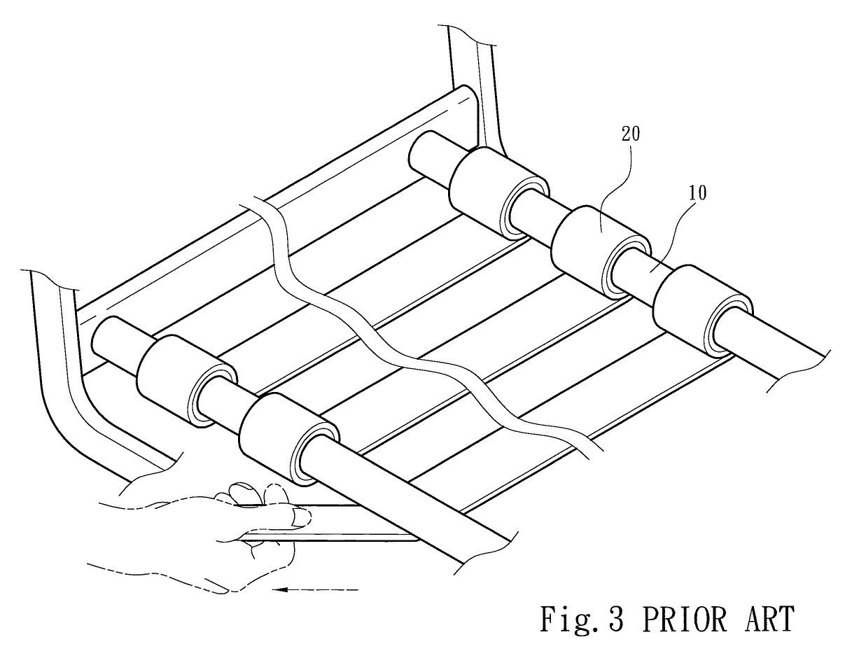

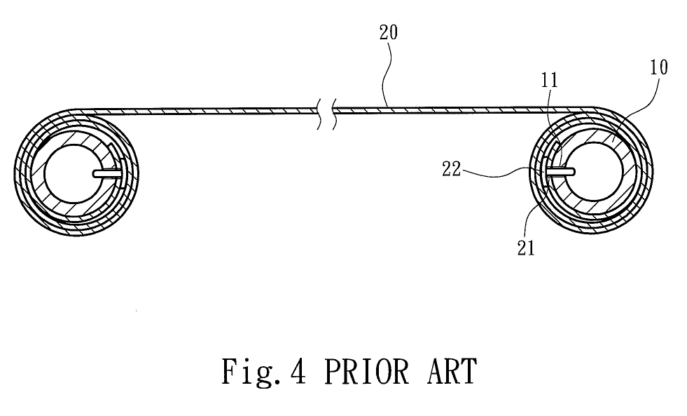

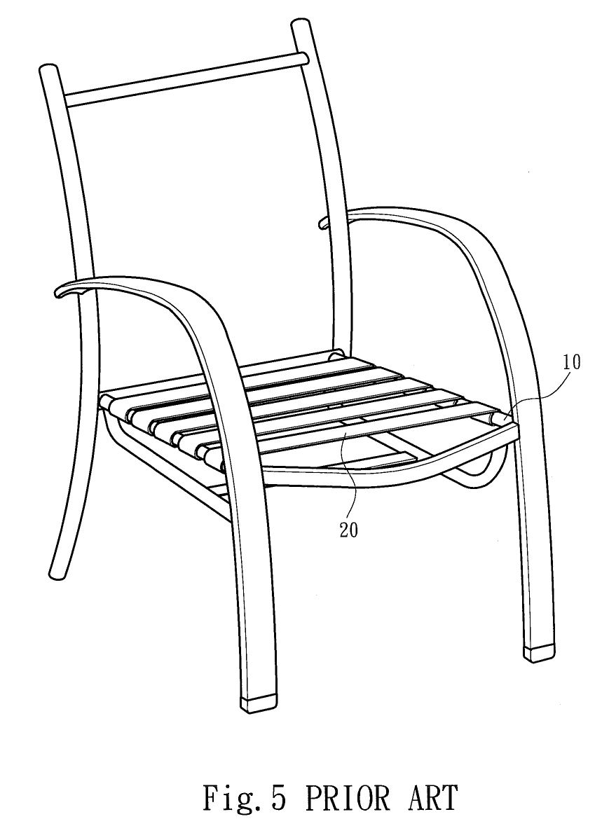

### DETAILED DESCRIPTION OF THE PREFERRED EMBODIMENT

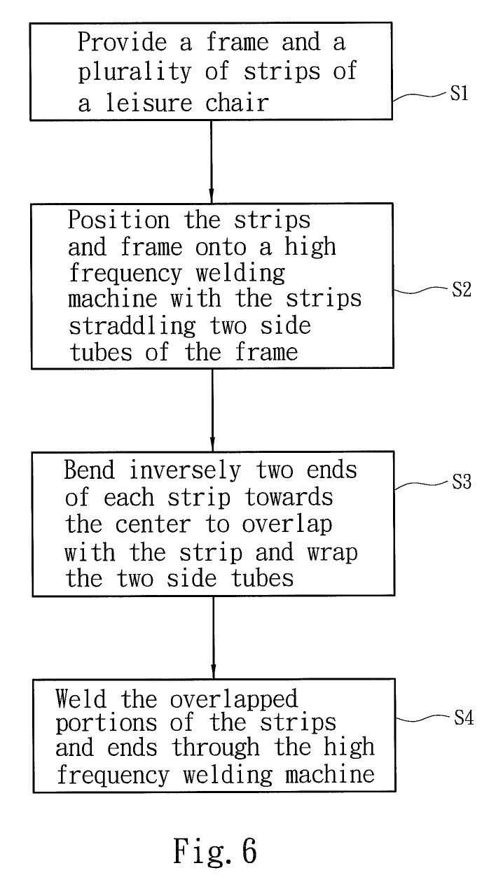

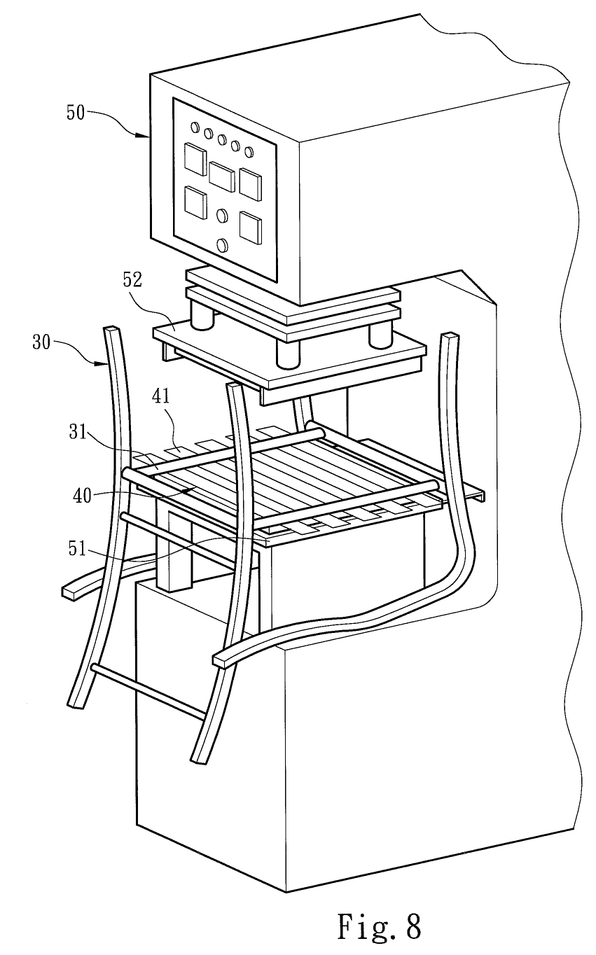

The present invention aims to provide a method for fastening strips 40 to a leisure chair to support sitting of a user. Please refer to FIGS. 6 through 10, step S1, providing a frame 30 of a leisure chair that can be the entire rack or a portion of the rack of the leisure chair. The entire rack is taken for discussion herein, but the frame 30 depicted in the structure in FIG. 8 can be the entire rack or a portion of the rack. The frame 30 mainly includes two side tubes 31 and a plurality of strips 40 respectively formed in elongated shape and made of PVC. Each strip 40 is formed at a length greater than the interval between the two side tubes 31.

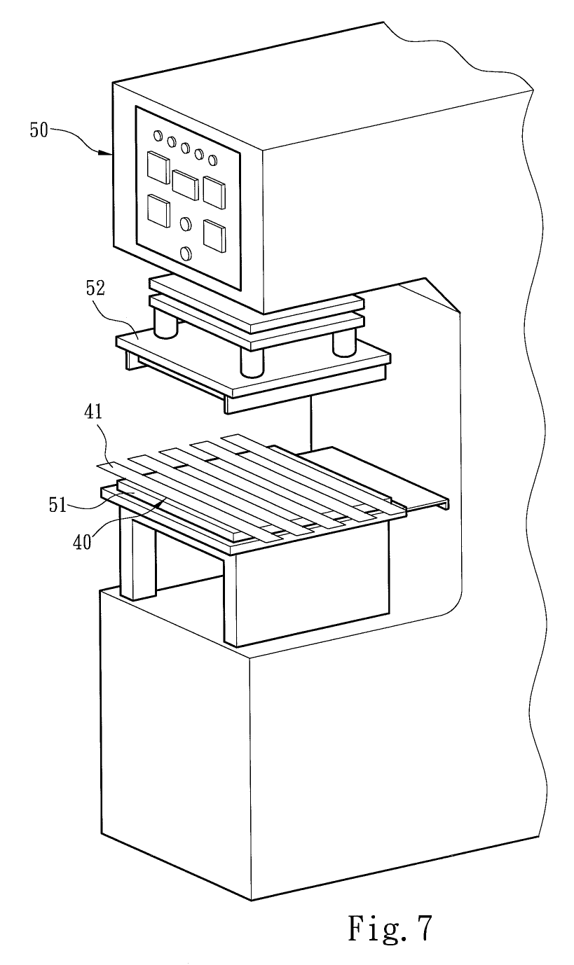

Step S2, positioning the strips 40 and frame 30 onto a welding machine 50 which has a welding platform 51 and a welding tool 52 located above the welding platform 51. First, the strips 40 are positioned onto the welding station 51 and spaced from each other in a parallel manner (referring to FIG. 7); next, the frame 30 is positioned onto the strips 40 so that the strips 40 are interposed between the welding platform 51 and frame 30 and straddle transversely the two side tubes 31. Since each strip 40 has a length longer than the interval between the two side tubes 31, when the frame 30 is positioned on the strips 40, two ends 41 of each strip 40 exceed the two side tubes 31 (referring to FIG. 8).

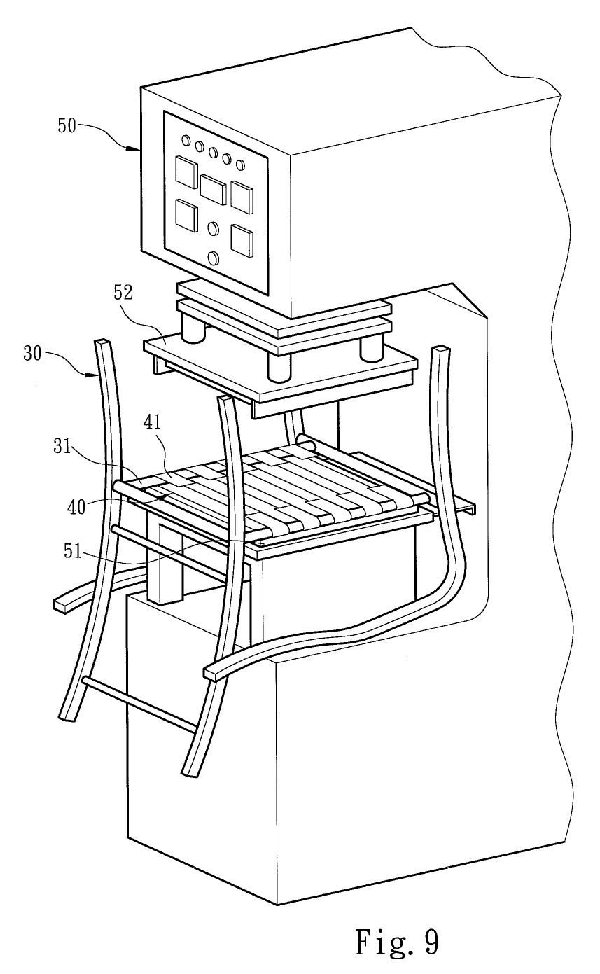

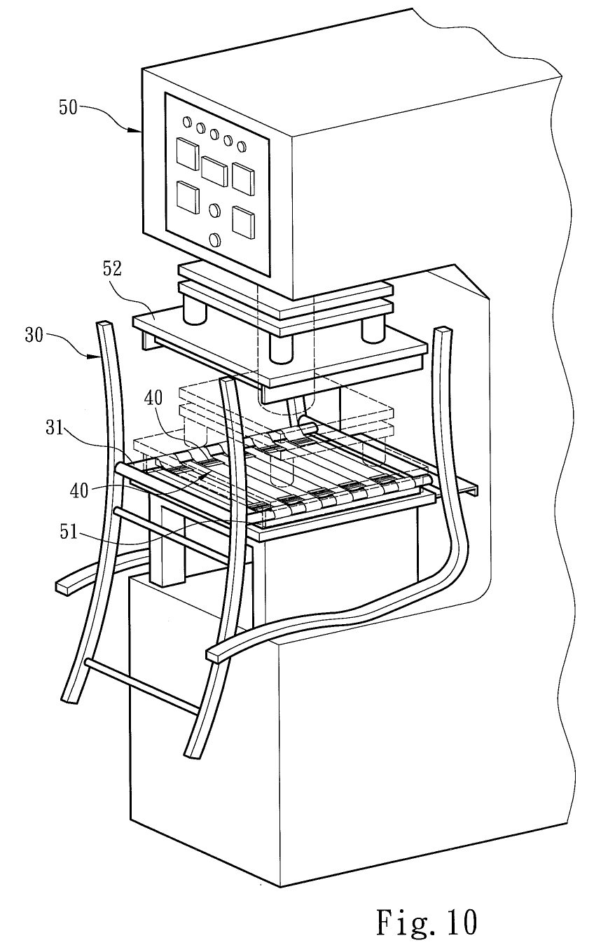

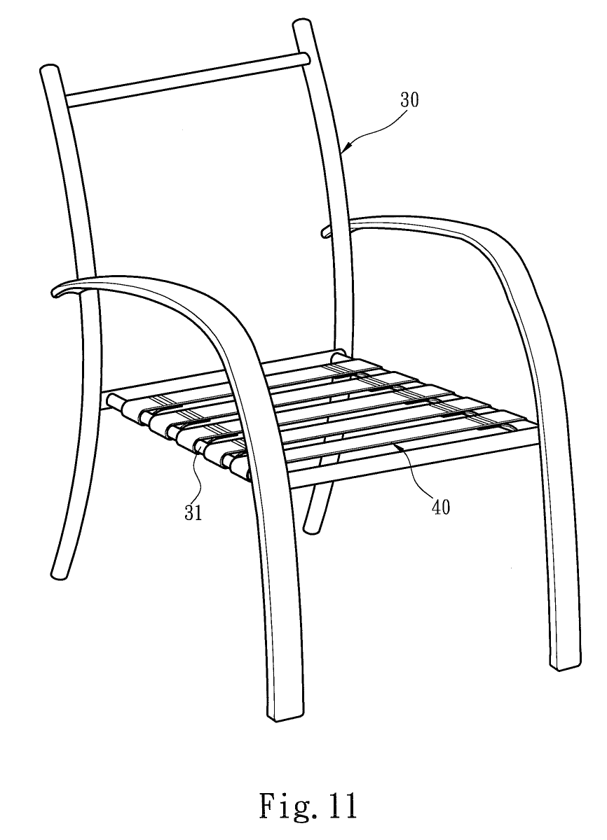

Step S3, bending the two ends 41 of each strip 40 exceeding the two side tubes 31 inversely towards the center to wrap the two side tubes 31 and overlap with the strip 40 (referring to FIG. 9); finally, step S4, moving the welding tool 52 downwards to press the overlapped portions of the strip 40 and the two ends 41 thereof, and activate the welding machine 50 to excite molecules inside the strip 40 and two ends 41 to interact with each other through high frequency to generate high temperature to form welding. Thereby the two ends 41 of the strip 40 fasten securely to the two side tubes 31 to finish fastening of the strip 40 (referring to FIG. 10).

Also referring to FIG. 11, the strips 40 are fastened to the frame 30 by welding to form a leisure chair, and thus the tedious work of manual assembly can be reduced and automatic production can be implemented to increase production speed and quantity through automatic equipment. While the embodiment shown in the drawings is a seat of the leisure chair formed by the strips 40, it is not the limitation of the usage of the strips 40, and they can also function as a backrest of the leisure chair to support a back of a user during sitting.

As a conclusion, the present invention mainly improves the winding fastening of the conventional technique by straddling and coupling a plurality of strips 40 on two side tubes 31 of the frame 30 of a leisure chair with two ends 41 of each strip 40 bent inversely towards the center to wrap the two side tubes 31; then the overlapped portions of the two ends 41 and strip 40 are welded and bonded together through high frequency welding. Compared with the conventional technique, the invention can weld and fasten multiple strips 40 simultaneously. Assembly can be done faster to reduce assembling time, and automatic production also can be adopted to increase production speed and quantity of leisure chairs.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method for fastening seat and backrest support of a leisure chair, comprising steps of:
providing a frame and a plurality of strips of a leisure chair, the frame including two corresponding side tubes, each of the strips being formed at a length greater than the interval between the two side tubes;
positioning the strips and the frame onto a welding machine to allow the strips to straddle the two side tubes of the frame;
bending inversely two ends of each strip towards the center to overlap with the strip and wrap the two side tubes; and
welding the overlapped portions of the strips and the ends thereof through the welding machine to fasten the two ends of each strip to the two side tubes.

2. The method of claim 1, wherein the strips are respectively formed in an elongated shape and made of PVC.

3. The method of claim 1, wherein the frame is an entire rack of the leisure chair.

4. The method of claim 1, wherein the frame is a portion of a rack of the leisure chair.

5. The method of claim 1, wherein the strips form a seat of the leisure chair.

6. The method of claim 1, wherein the strips form a backrest of the leisure chair.
